(19) United States
(12) Patent Application Publication
(10) Pub. No.: US 2014/0301403 A1
(43) Pub. Date: Oct. 9, 2014

(54) NODE DEVICE AND METHOD FOR PATH SWITCHING CONTROL IN A RING NETWORK

(71) Applicant: NEC CORPORATION, Tokyo (JP)

(72) Inventor: Yuusuke Yabe, Tokyo (JP)

(21) Appl. No.: 14/354,781

(22) PCT Filed: Oct. 26, 2012
(86) PCT No.: PCT/JP2012/006874

§ 371 Date: Apr. 28, 2014

(30) Foreign Application Priority Data
Oct. 28, 2011 (JP) 2011-237912

(51) Int. Cl. H04L 12/741

(52) U.S. Cl. CPC H04L 45/54
USPC 370/410

(57) ABSTRACT

A node device and a method for path switching control in the same are provided that can achieve easier network maintenance, reduced loads on the network, and faster path switching in the event of a failure. A node device includes a storage section for storing a forwarding table (FDB) and a management table (RDB), wherein the forwarding table associates a destination node device of forwarded data with an address of the destination node device on the ring network, wherein the management table associates the destination node device with port information on a port to be used for forwarding data to the destination node device; and a control section for updating an association of the destination node device with the port information in the management table without changing the forwarding table when a transfer path of the forwarded data is changed.

### TECHNICAL FIELD

The present invention relates to path switching techniques in ring networks and, more particularly, to a method for path switching control in the event of a failure and a node device including such functionality.

### BACKGROUND ART

For a path switching technique in the event of a communication failure in a ring network, Ethernet Ring Protection (here, “Ethernet” is a registered trademark; the same applies hereinafter) is known that is defined in ITU-T (International Telecommunication Union Telecommunication Standardization Sector) G. 8032. According to Ethernet Ring Protection, when a master node on a ring network receives a failure message from a node adjacent to a failed place, the master node unblocks a normally blocking port and issues instructions to clear a MAC (Media Access Control) address table to all nodes on the ring network. Since a node in which the MAC table is cleared due to this operation cannot know a destination node until the MAC table relearns, the node floods an arriving data frame onto the ring network.

Moreover, PTL 1 discloses a method by which pieces of path information are pre-set for the time of normal operation and for the event of a failure, respectively, and when receiving a failure occurrence notification as a trigger, a backup path is identified and a switch to the backup path is made.

### CITATION LIST

### Patent Literature

[PTL 1]

Japanese Patent Application Unexamined Publication No. 2011-066564

### SUMMARY OF INVENTION

### Technical Problem

However, according to the above-mentioned Ethernet Ring Protection in ITU-T, when a failure occurs on a ring network, since the MAC address tables of all nodes are cleared, it is necessary to perform flooding until the MAC address tables relearn to be the same as before paths are switched, causing the problem of increasing traffic on the network and weighting down network resources. Further, since time is required for the MAC address tables to relearn, it may be difficult to satisfy the allowed path switching time, 50 ms, as defined in ITU-T G8032.

Furthermore, according to the path switching method disclosed in PTL 1, a maintainer needs to pre-set path information for the time of normal operation and for the event of a failure, respectively. Therefore, in a ring network, where the addition of nodes is performed on an ordinary basis to extend the network, network maintenance is complicated, and burden on the maintainer is increased. Moreover, in the method of PTL 1, as in the above-described Ethernet Ring Protection, there are some cases where processing for flowing data in both directions (flooding) is performed until a certain period of time passes when a failure occurs, and what is more, it is necessary to flow control frames to all paths because determination to switch paths in the event of a failure depends on a path switching control frame from a master node.

Accordingly, an object of the present invention is to provide a node device and a method for path switching control in a ring network, which can achieve easier network maintenance, reduced loads on the network, and faster path switching in the event of a failure.

### Solution to Problem

A node device according to the present invention is a node device included in a ring network, characterized by comprising: a plurality of ports connecting to the ring network; storage means for respectively storing a forwarding table, in which a destination node device of forwarded data and an address thereof on the ring network are associated with each other, and a management table, in which the destination node device and information on a port to be used for forwarding data to the destination node device are associated with each other; and control means that, when a forwarding path of the forwarded data is changed, updates an association of the destination node device with the port information in the management table, without changing the forwarding table.

A method for path switching control according to the present invention is a method for path switching control in a ring network in which a plurality of node devices are connected in a ring topology, characterized by comprising: by each node, storing in storage means a forwarding table, in which a destination node device of forwarded data and an address thereof on the ring network are associated with each other, and a management table, in which the destination node device and information on a port to be used for forwarding data to the destination node device are associated with each other; and by each node, when a forwarding path of the forwarded data is changed, updating an association of the destination node device with the port information in the management table, without changing the forwarding table.

A ring network according to the present invention is a ring network in which a plurality of node devices are connected in a ring topology, characterized in that each node device comprises a plurality of ports connecting to the ring network, and storage means for respectively storing a forwarding table, in which a destination node device of forwarded data and an address thereof on the ring network are associated with each other, and a management table, in which the destination node device and information on a port to be used for forwarding data to the destination node device are associated with each other, and when a forwarding path of the forwarded data is changed, each node device updates an association of the destination node device with the port information in the management table, without changing the forwarding table.

A program according to the present invention is a program causing a computer to function as a node device that is included in a ring network and that has a plurality of ports connecting to the ring network, characterized by causing the computer to implement: functions of respectively storing a forwarding table, in which a destination node device of forwarded data and an address thereof on the ring network are associated with each other, and a management table, in which the destination node device and information on a port to be used for forwarding data to the destination node device are associated with each other; and a function of updating an association of the destination node device with the port information in the management table, without changing the forwarding table, when a forwarding path of the forwarded data is changed.

### Advantageous Effects of Invention

According to the present invention, it is possible to achieve easier network maintenance, reduced loads on a network, and faster path switching in the event of a failure.

### BRIEF DESCRIPTION OF DRAWINGS

FIG. 1A is a schematic network topology diagram for explaining operations during normal operation in a ring network according to an exemplary embodiment of the present invention, and FIG. 1B is a format diagram of a data frame in the present exemplary embodiment.

FIG. 2 is a block diagram showing a schematic configuration of a node device according to the present exemplary embodiment.

FIG. 3 is a sequence diagram showing update operations of forwarding database and ring database, for explaining an outline of path switching control according to the present exemplary embodiment.

FIG. 4 is a flowchart showing a frame forwarding operation in a node device at normal times according to an example of the present invention.

FIG. 5 is a flowchart showing update operations of forwarding database and ring database in the node device at normal times according to the present example.

FIG. 6 is a schematic diagram showing an example of the learning results of the forwarding database and the ring database at normal times in each node of a ring network according to the present example.

FIG. 7A is a schematic network topology diagram for explaining an outline of path switching control in the event of a failure according to the present example, and FIG. 7B is a format diagram of a failure notification message in the present exemplary embodiment.

FIG. 8A is a diagram showing a format of the failure notification message shown in FIG. 7 that is sent by a node N2 in the event of a failure, and FIG. 8B is a diagram showing a format of the failure notification message shown in FIG. 7 that is sent by a node N3 in the event of a failure.

FIG. 9 is a diagram showing a format of the failure notification message shown in FIG. 7 that is sent by a node N1 in the event of a failure.

FIG. 10 is a diagram showing a format of the failure notification message shown in FIG. 7 that is sent by a node N4 in the event of a failure.

FIG. 11 is a flowchart showing a frame forwarding operation of the node device in the event of a failure according to the present example.

FIG. 12A is a flowchart showing the updating operation of a ring database in the event of a failure, at a node that is the node device according to the present example and is adjacent to a place where the failure occurs, and FIG. 12B is a flowchart showing the updating operation of a ring database in the event of a failure, at a node that is the node device according to the present example and is a relay node.

FIG. 13 is a schematic diagram showing an example of the updating results of the forwarding database and the ring database after a failure occurs at each node in the ring network according to the present example.

FIG. 14A is a flowchart showing the updating operation of a ring database in recovery from a failure, at a node that is the node device according to the present example and is adjacent to a place where the failure occurs, and FIG. 14B is a flowchart showing the updating operation of a ring database in recovery from a failure, at a node that is the node device according to the present example and is a relay node.

FIG. 15 is a format diagram of a data frame according to another example of the present invention.

### DESCRIPTION OF EMBODIMENTS

As described above, in a ring network according to the background art, when a failure occurs on the network and the topology is changed, it is necessary to clear the forwarding tables of individual nodes on the network, each forwarding table including the MAC address of a destination node. However, in actuality, the destination node is unchanged before and after the topology is changed in the ring network, and it is sufficient to appropriately determine which port side of each node the destination node is located on and to make a switch thereto.

The present invention is made from this point of view. When switching takes place, forwarding tables are maintained without being cleared, and only management tables, which show which port side of each node a destination node is located on, are updated, whereby it is possible to achieve faster path switching without imposing loads on a network.

More specifically, each node on a ring network according to the present invention includes a forwarding table that learns the address of a destination node and a management table for identifying a transmission port on the destination node side, and the forwarding table and the management table are managed as follows. That is, when a failure occurs on the ring network, the forwarding table is maintained without being cleared, and the management table is updated by associating the source node number and relay node number(s) added to a received failure notification message with the port at which the failure notification message is received. This control is based on an operation such that in a single ring network, information in the forwarding table is unchanged before and after paths are switched and only the management table is changed.

Moreover, in update of a forwarding port for a destination node after a failure occurs, a method is employed in which a failure notification message is forwarded to all nodes in the ring, with their own node numbers being pushed into the message, whereby it is possible to suppress flooding, which has been inevitable to happen from the occurrence of a failure up until the forwarding tables relearn, and it is also possible to achieve faster path switching operation.

As described above, according to the present invention, it is possible to perform path switching only by referring to the maintained forwarding tables and the updated management tables, allowing reduced time for path switching, and also to efficiently use network resources because flooding is suppressed. Hereinafter, an exemplary embodiment of the present invention will be described in detail with reference to drawings.

### 1. EXEMPLARY EMBODIMENT

In a ring network according to the present invention, a desired number of communication devices (nodes) can be connected. However, in the present exemplary embodiment, to avoid complicating the description, a ring network in which four nodes are connected will be illustrated as an example hereinafter.

In the present exemplary embodiment, a forwarding table and a management table provided to each node will be referred to as FDB (Forwarding Data Base) table and RDB (Ring Data Base) table, respectively. The FDB table is a table that learns unique numbers destination nodes have in units of MAC address (hereinafter, referred to as node numbers), and the RDB table is a table that learns which of port sides connected to the ring network the destination nodes are located on.

### 1.1) Ring Network

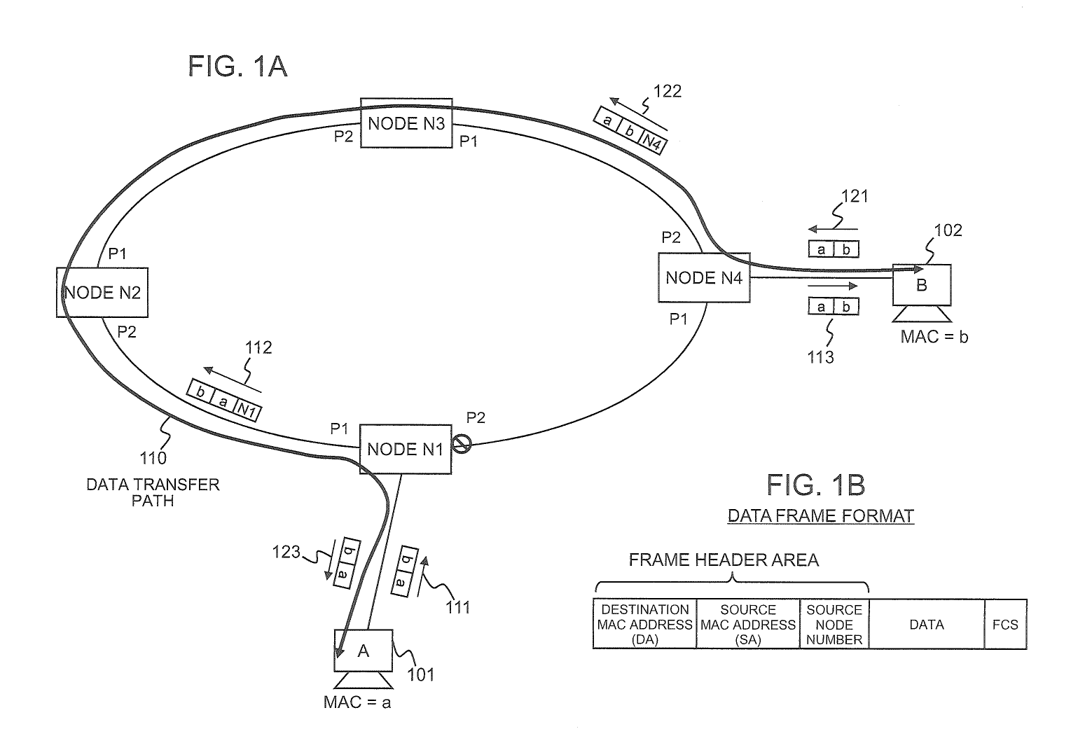

Referring to FIG. 1A, the ring network according to the present exemplary embodiment includes a plurality of nodes N1 to N4 connected in a ring topology, and the node N1 is a master node here. Moreover, at each node, a port transmitting data clockwise is denoted by P1, while a port transmitting data counterclockwise is denoted by P2, and the port P2 of the master node N1 is blocked during normal operation. Accordingly, assuming that a terminal 101 (MAC address=a) of a user A is connected to the node N1 and a terminal 102 (MAC address=b) of a user B is connected to the node N4, the user terminals 101 and 102 can perform data communication through a single path 110.

In a data frame used for transmission and reception, used is a header format to which a source node number is added, in addition to ordinary fields used in Ethernet. Specifically, a source node number is added to a header area, between a source MAC address field and a VLAN tag. When the node N1 receives an ordinary data frame with a header 111 (destination MAC address DA=b, source MAC address SA=a) from the user terminal 101, the node N1 adds a source node number (its own node number N1) to the frame header area and transmits the data frame with a header 112 from the port Pl. When the data frame with the header 112 enters the port P2 of the node N4 via the nodes N2 and N3, the node N4 transmits the ordinary data frame with a header 113 (destination MAC address DA=b, source MAC address SA=a) to the destination user terminal 102. Similarly, when the node N4 receives an ordinary data frame with a header 121 (destination MAC address DA=a, source MAC address SA=b) from the user terminal 102, the node N4 adds a source node number (its own node number N4) to the frame header area and transmits the data frame with a header 122 from the port P2. When the data frame with the header 122 enters the port P1 of the node N1 via the nodes N3 and N2, the node N1 transmits the ordinary data frame with a header 123 (destination MAC address DA=a, source MAC address SA=b) to the destination user terminal 101.

### 1.2) Node Configuration

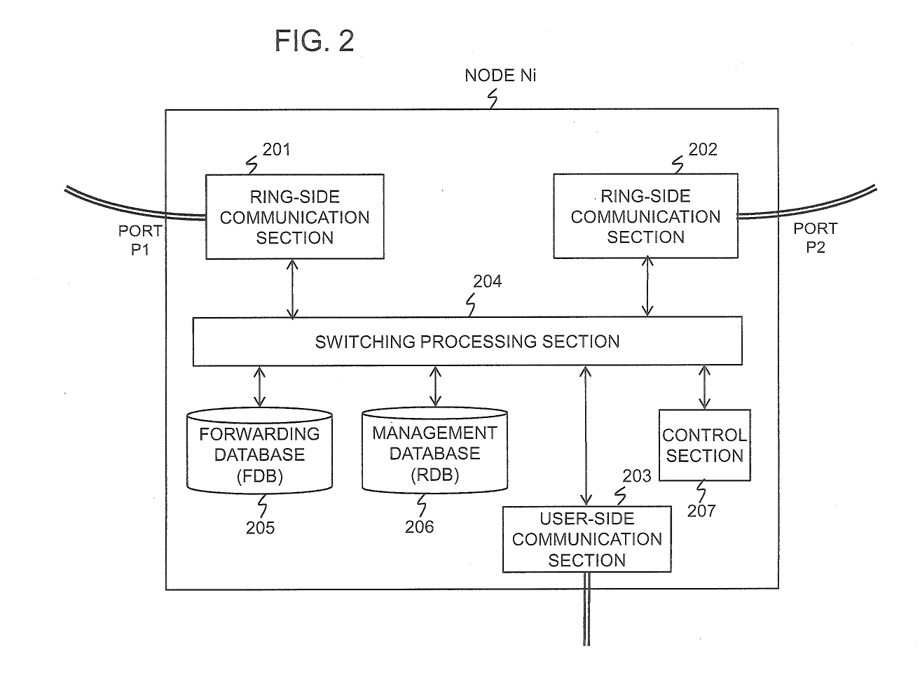

Referring to FIG. 2, each node Ni (here, i=1, 2, 3, or 4) included in the ring network has ring-side communication sections 201 and 202 corresponding to the ports P1 and P2 connecting to the ring network, respectively. The node Ni is capable of communicating with a user terminal through a user-side communication section 203. The node Ni further includes a switching processing section 204, a forwarding database (FDB) 205 storing the FDB table, a management database (RDB) 206 storing the RDB table, and a control section 207 that controls overall operations of the node. As described already, the FDB 205 learns destination node numbers in units of MAC address, while the RDB 206 learns which one of the ring-side communication sections 201 and 202 the destination nodes are located on. When a failure occurs on the ring network, the control section 207 maintains the FDB 205 and updates the RDB 206 by associating a source node number and relay node number(s) added to a received failure notification message with a port at which the failure notification message is received, which will be described later. The switching processing section 204, under control of the control section 207, performs operations of adding/deleting a source node number to/from a received data frame and forwarding by referring to the FDB 205 and the RDB 206.

Note that functions of the control section 207 described below can also be implemented by executing programs stored in a memory (not shown) on a computer.

### 1.3) Operation

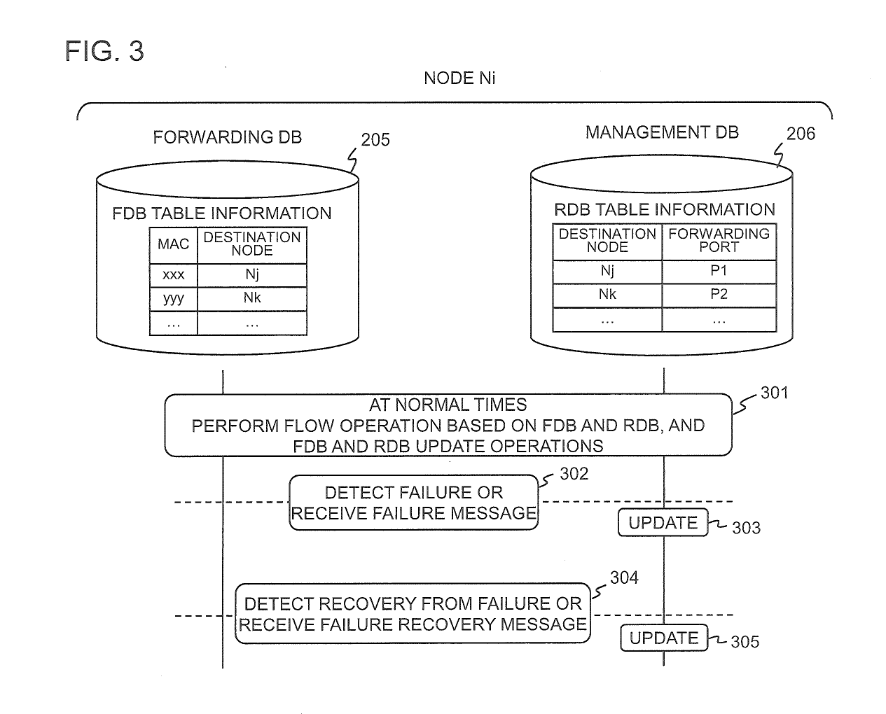

Referring to FIG. 3, the FDB table in the FEB 205 of each node Ni stores a MAC address and a destination node number which are associated with each other, while the RDB 206 stores the destination node number and a forwarding port to be used for forwarding data to this destination node, which are associated with each other.

When the ring network is normally operating, the control section 207 of each node Ni updates the FDD 205 and the RDB 206, and the switching processing section 204 performs forwarding operations by referring to the FDB 205 and the RDB 206 (Operation 301). Specifically, the switching processing section 204 searches the FDB 205 based on a destination MAC address of a received data frame to identify a destination node, and subsequently searches the RDB 206 to identify a forwarding port to use for forwarding data to this destination node.

When a failure occurs on the ring network and a failure notification message arrives at a node Ni (Operation 302), the control section 207 maintains the FDB 205 and updates the RDB table of the RDB 206 in such a manner that the destination node is associated with an available forwarding port, based on source node and relay node information added to the received failure notification message and on a port number at which the failure notification message has been received (Operation 303). When detecting recovery from the failure (Operation 304), the control section 207 restores or updates the RDB 206 (Operation 305) and returns to normal operation operations (Operation 301).

### 1.4) Effects

As described above, according to the present exemplary embodiment, each node can learn a forwarding port for a destination node, based on a source node number added to a data frame during normal operation, or based on a source node number and a relay node number (or numbers) added to a failure notification message in the event of a failure, without a maintainer pre-setting a path. Accordingly, network maintenance is particularly facilitated in a ring network where the addition of nodes is performed on a usual basis to extend the network.

Moreover, according to the present exemplary embodiment, since the FDB 205 is maintained and only the RDB 206 is updated, it is possible to switch paths without flooding data, avoiding a situation in which the network is unnecessarily loaded in bandwidth.

Further, according to the present exemplary embodiment, a source node number and each relay node number are added to a failure notification message, which is notified to each node in the ring in the event of a failure. Accordingly, update of path information and path switching can be made by a single control frame.

### 2. EXAMPLE

Hereinafter, a detailed description will be given of path learning operation of each node and path switching control in the event of a failure according to an example of the present invention, with reference to drawings.

### 2.1) Path Learning Operation at Normal Times

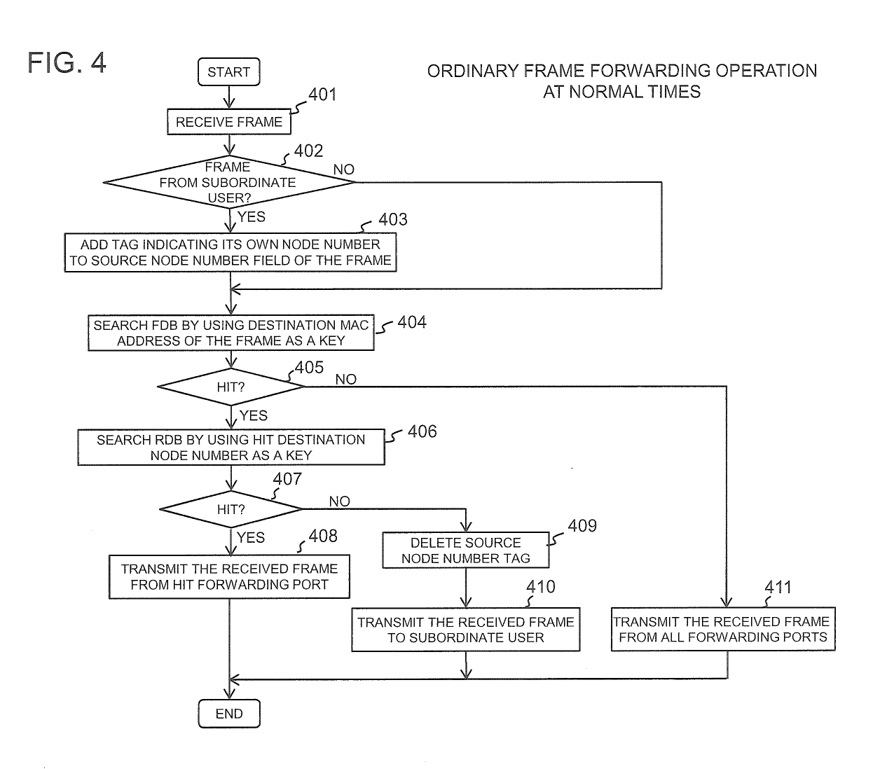

Referring to FIG. 4, when a node Ni receives a frame through a ring-side communication section at some port (Operation 401), the switching processing section 204 determines whether or not the frame is one from its subordinate user which is controlled by itself (Operation 402) and, when it is a frame from the subordinate user (Operation 402; YES), adds a tag indicating its own node number to the source node number field of the received frame (Operation 403). Operation 403 is not performed if the frame is not one from a subordinate user (Operation 402; NO).

Subsequently, the switching processing section 204 searches the FDB 205 by using a destination MAC address in the header of the received frame as a key (Operation 404). If the FDB 205 stores a destination node associated with this destination MAC address (Operation 405; YES), the switching processing section 204 searches the RDB 206 by using the hit destination node's number as a key (Operation 406). If the RDB 206 stores a forwarding port associated with this destination node (Operation 407; YES), the switching processing section 204 transmits the received frame on to the ring network through a ring-side communication section at the hit forwarding port (Operation 408).

If the RDB 206 does not store a forwarding port associated with the destination node (Operation 407; NO), the switching processing section 204 deletes a source node number tag from the header of the received frame (Operation 409) and transmits the received frame to the subordinate user terminal through the user-side communication section 203 (Operation 410). If the FDB 205 does not store a destination node associated with the destination MAC address of the received frame (Operation 405; NO), the switching processing section 204 transmits the received frame from every forwarding port (Operation 411).

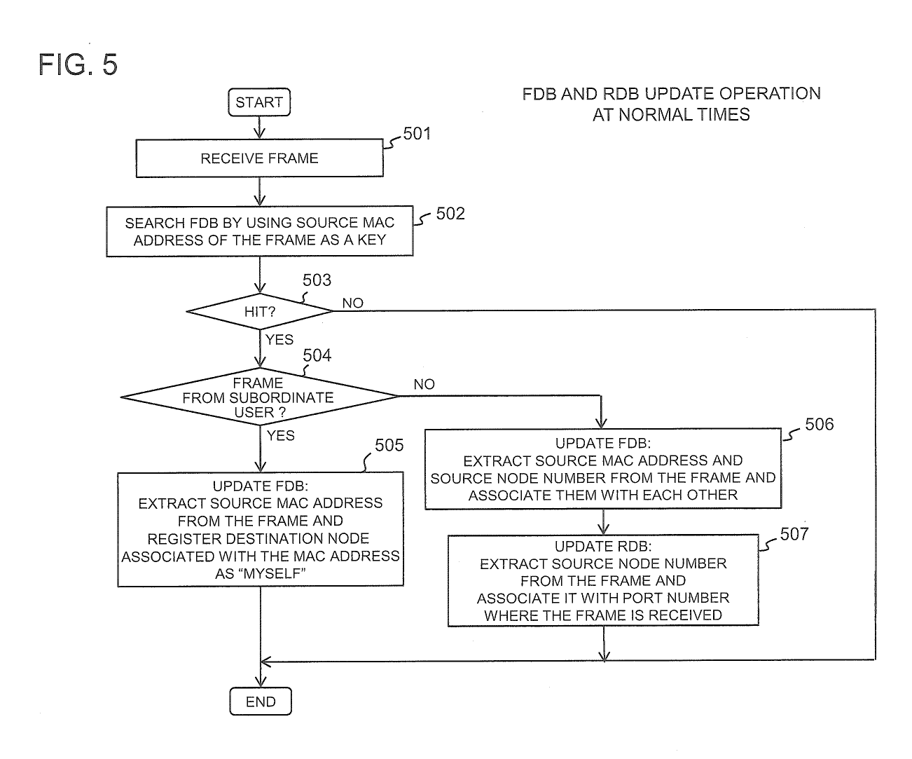

Referring to FIG. 5, when a node Ni receives a frame through a ring-side communication section at some port (Operation 501), the switching processing section 204 searches the FDB 205 by using a destination MAC address in the header of the received frame as a key (Operation 502). If the FDB 205 stores a destination node associated with this destination MAC address (Operation 503; YES), the switching processing section 204 determines whether or not the frame is one from a subordinate user (Operation 504), and when it is a frame from the subordinate user (Operation 504; YES), the control section 207 extracts a source MAC address from the received frame and updates the FDB 205 such that a destination node associated with this address is “myself” (Operation 505).

If the received frame is not a frame from a subordinate user (Operation 504; NO), the control section 207 extracts a source MAC address and a source node number from the received frame and updates the FDB 205 such that they are associated with each other (Operation 506). Further, the control section 207 updates the RDB 206 such that the source node number in the received frame is associated with the port number at which this received frame has been received (Operation 507). Note that the updating operation is not performed if the FDB 205 does not store a destination node associated with the destination MAC address of this received frame (Operation 503; NO).

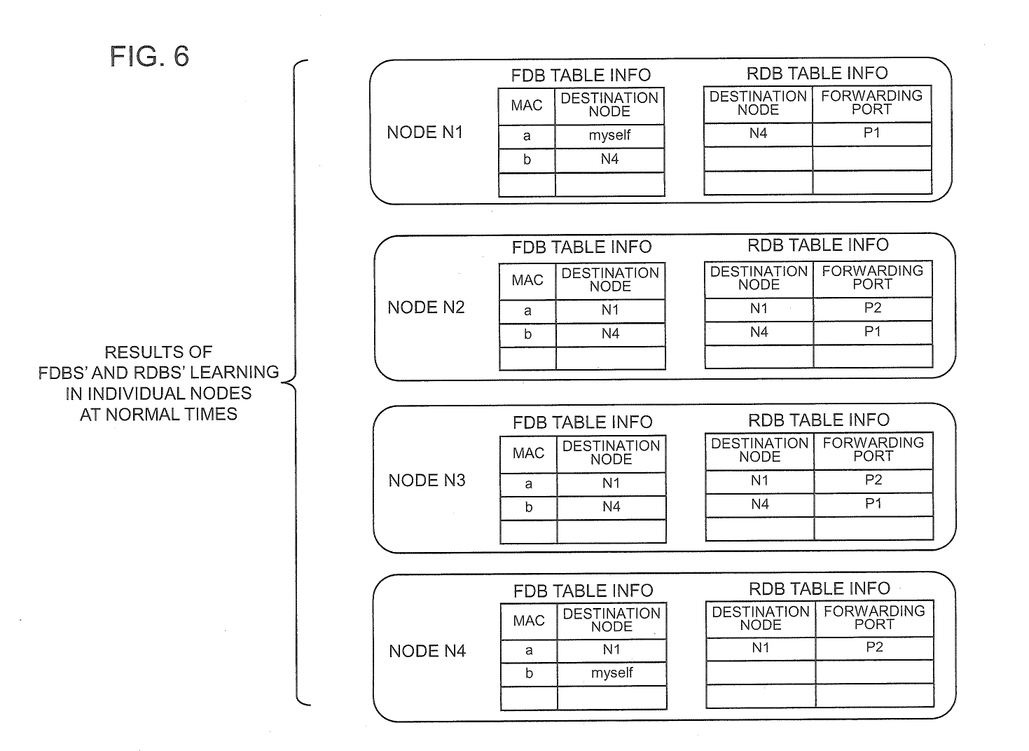

Next, an example of the path learning operation in the ring network will be described with reference to FIG. 6.

The node N1, when receiving a frame to be transferred from the user terminal 102 to the user terminal 101 at the port P1, performs the learning operation based on information in its header area 122. That is, the node N1 registers the MAC address (b) of the user terminal 102 and a destination node number N4 in the FDB table of the FDB 205 with associating them with each other (Operation 506 in FIG. 5), and registers the destination node number N4 and a forwarding port number P1 in the RDB table of the RDB 206, which are associated with each other (Operation 507 in FIG. 5).

The node N2, when receiving the above-described frame to be transmitted from the user terminal 102 to the user terminal 101 at the port P1, registers the MAC address (b) of the user terminal 102 and a destination node number N4 in the FDB table of the FDB 205 with associating them with each other based on its header 122 (Operation 506 in FIG. 5), and registers the destination node number N4 and a forwarding port number P1 in the RDB table of the RDB 206 with associating them with each other (Operation 507 in FIG. 5). The node N2, when receiving a frame to be transmitted from the user terminal 101 to the user terminal 102 at the port P2, similarly learns from information in its header area 112. That is, the node N2 registers the MAC address (a) of the user terminal 101 and a destination node number N1 in the FDB table of the FDB 205, with associating them with each other (Operation 506 in FIG. 5), and registers the destination node number N1 and a forwarding port number P2 in the RDB table of the RDB 206, with associating them with each other (Operation 507 in FIG. 5).

The node N3, similarly to the node N2, learns from information in the header areas 122 and 112 and updates the FDB table and the RDB table as shown in FIG. 6.

The node N4, when receiving the frame to be transmitted from the user terminal 101 to the user terminal 102 at the port P2, similarly learns from information in its header area 112. That is, the node N4 registers the MAC address (a) of the user terminal 101 and a destination node number N1 in the FDB table of the FDB 205, with associating them with each other (Operation 506 in FIG. 5), and registers the destination node number N1 and a forwarding port number P2 in the RDB table of the RDB 206 with associating them with each other (Operation 507 in FIG. 5).

### 2.2) Operation in the Event of a Failure

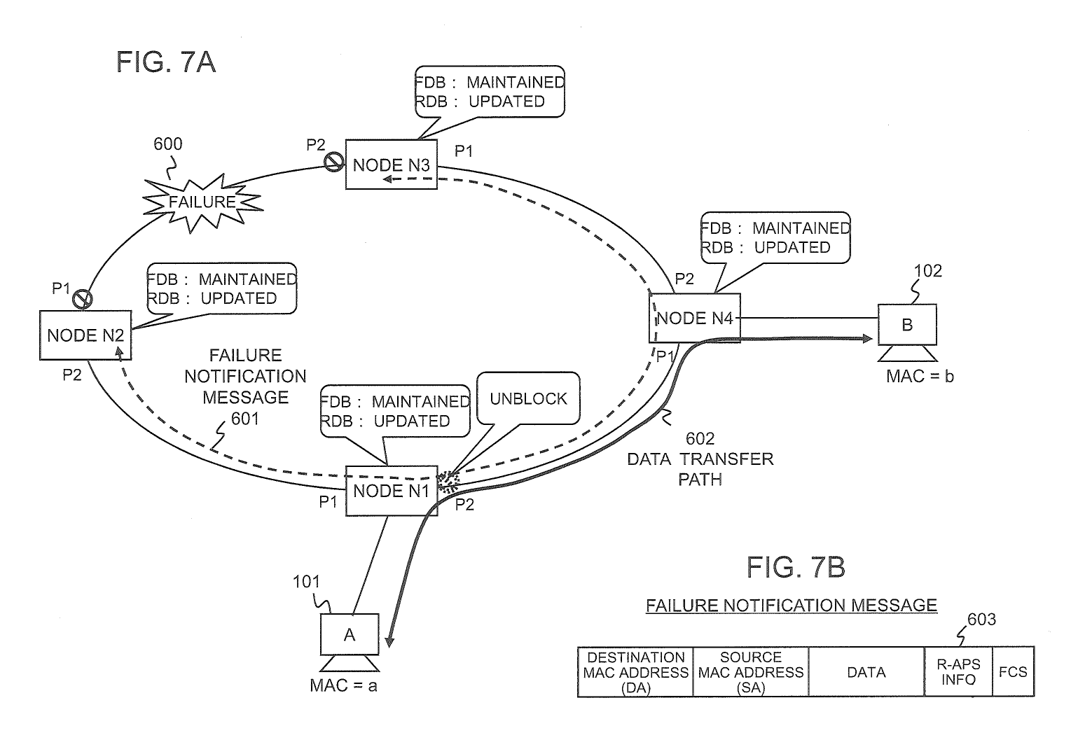

Referring to FIG. 7A, assuming that a failure occurs on the network between the nodes N2 and N3, the nodes N2 and N3 adjacent to a failed place 600 block the ports P1 and P2 connecting to a link where the failure occurs, respectively, and each send out a failure notification message 601 from the ports P2 and P1, respectively. The master node N1, when receiving the failure notification message 601, unblocks the blocking port P2, while all the nodes N1 to N4 maintain the FDB tables of their FDBs 205 and update the RDB tables of their RDBs 206 based on information on a source node in the failure notification message 601 and on the receiving ports. For example, the RDB table of the node N1 is updated such that the forwarding port associated with the destination node N4 is changed from P1 to the port P2 unblocked, and the RDB table of the node N4 is updated such that the forwarding port associated with the destination node N1 is changed from P2 to the port Pl. Thereby, communication between the user terminals 101 and 102 is switched from the path 110 as shown in FIG. 1 to a new data transfer path 602.

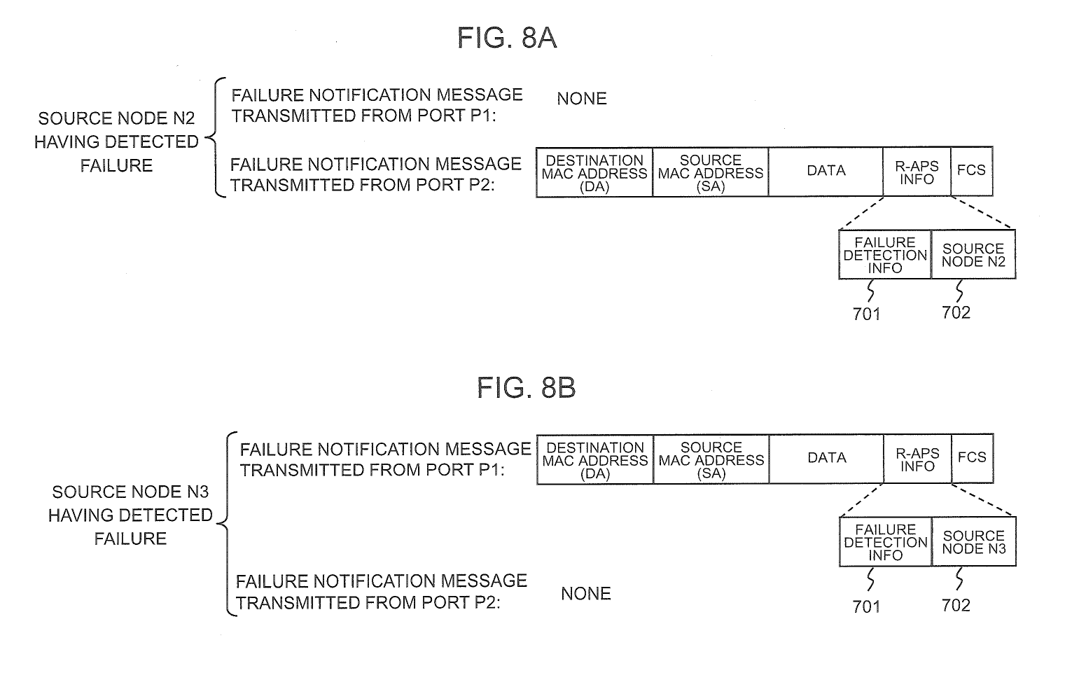

The failure notification message 601 has a frame format including a R-APS (Ring-Automatic Protection Switching) information field 603, as shown in FIG. 7B. The R-APS information field 603 includes a failure detection information field 701, a source node number field 702, and a relay node number field 703 if existing, which will be described next. A node having received the failure notification message 601 can learn the occurrence of a failure and a path through which the failure notification message arrives by referring to the R-APS information. Hereinafter, a concrete example of the failure notification message to be transmitted or forwarded from a port of each node will be illustrated with reference to FIGS. 8 to 10.

Referring to FIG. 8A, the node N2 having detected a failure transmits nothing from the port P1 and transmits a failure notification message from the port P2. Failure detection information and the node number of this node N2 as a source are stored in the P-APS information field of this failure notification message. Referring to FIG. 8B, the node N3 having detected the failure transmits a failure notification message from the port P1 and transmits nothing from the port P1. Failure detection information and the node number of this node N3 as a source are stored in the P-APS information field of this failure notification message.

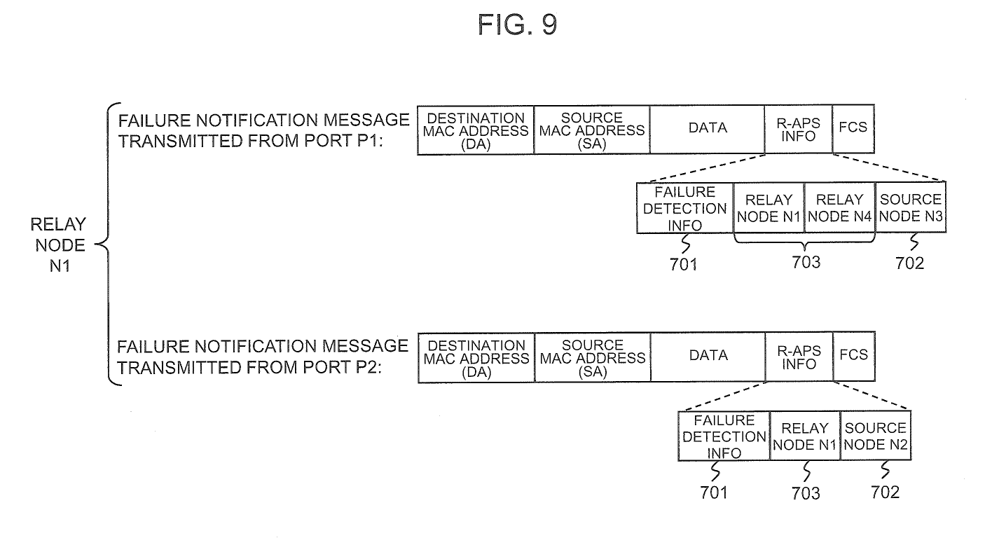

Referring to FIG. 9, the node N1 receives the failure notification messages from the adjacent nodes N4 and N2 at the ports P2 and P1, respectively, adds its own node number to the relay node field 703 of each failure notification message, and transmits the failure notification messages from the opposite ports P1 and P2, respectively. That is, the node N1 adds its own node number N1 as a relay node to the P-APS information field of the failure notification message to be transmitted from the port P1, in addition to the failure detection information, the source node number N3, and the relay node number N4. Similarly, the node N1 adds its own node number N1 as a relay node to the P-APS information field of the failure notification message to be transmitted from the port P2, in addition to the failure detection information and the source node number N2.

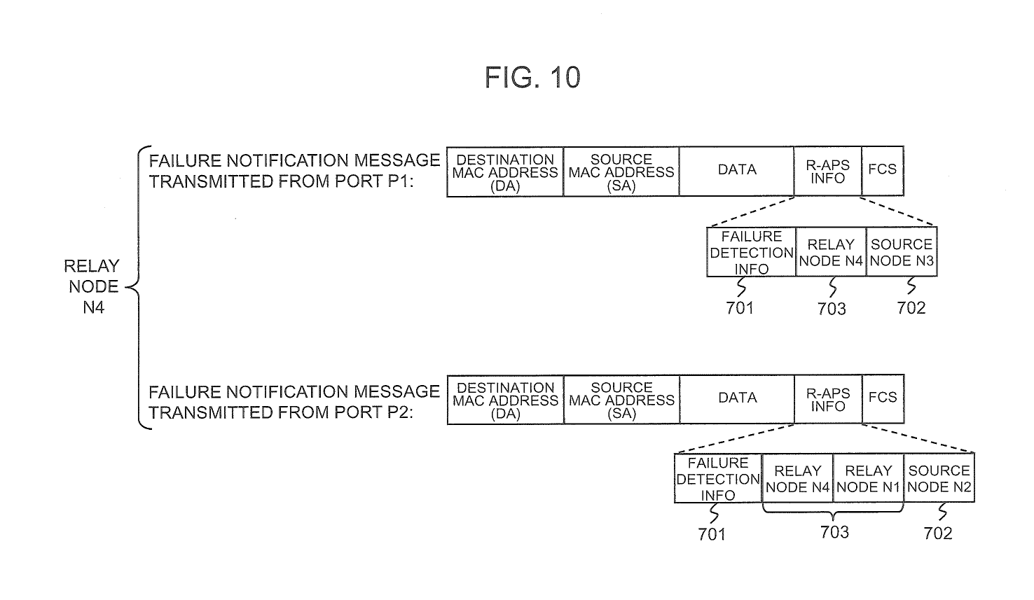

Referring to FIG. 10, the node N4 receives the failure notification messages from the adjacent nodes N3 and N1 at the ports P2 and P1, respectively, adds its own node number to the relay node field 703 of each failure notification message, and transmits the failure notification messages from the opposite ports P1 and P2, respectively. That is, the node N4 adds its own node number N4 as a relay node to the P-APS information field of the failure notification message to be transmitted from the port P1, in addition to the failure detection information and the source node number N3. Similarly, the node N4 adds its own node number N4 as a relay node to the P-APS information field of the failure notification message to be transmitted from the port P2, in addition to the failure detection information, the source node number N2, and the relay node number N1.

### 2.3) Frame Forwarding Operation in the Event of a Failure

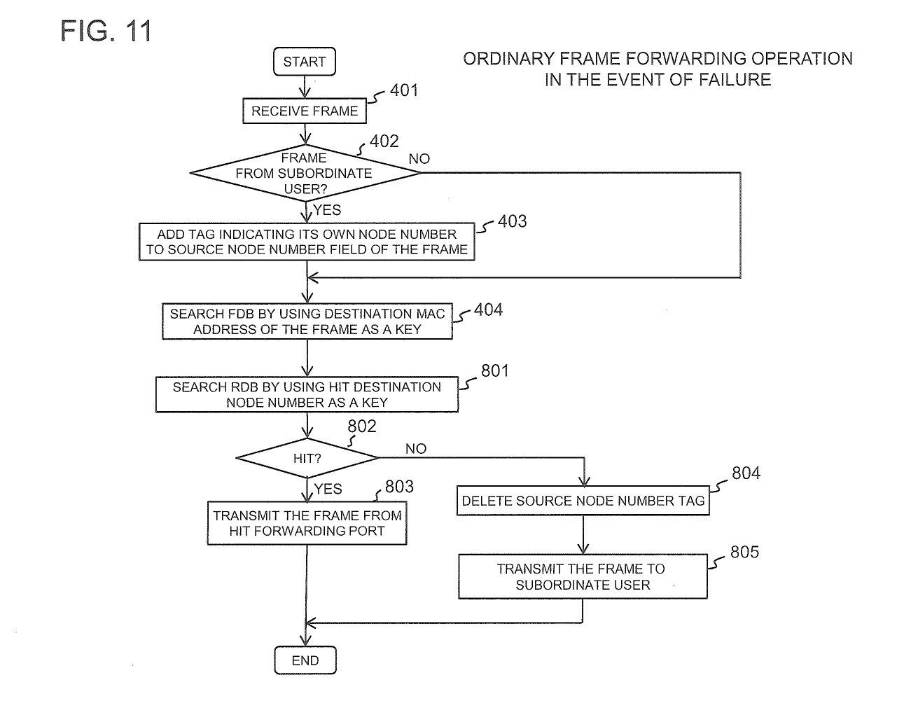

Referring to FIG. 11, since Operations 401 to 404 are the same as the frame forwarding operation during normal operation as shown in FIG. 4, they are given the same reference numerals and a description thereof will be omitted. The switching processing section 204 of each node Ni searches the RDB 206 by using as a key a destination node number hit in the search of the FDB (Operation 801). If the RDB 206 stores a forwarding port associated with this destination node (Operation 802; YES), the switching processing section 204 transmits the received frame on to the ring network through a ring-side communication section at the hit forwarding port (Operation 803). If the RDB 206 does not store a forwarding port associated with the destination node (Operation 802; NO), the switching processing section 204 deletes a source node number tag from the header of the received frame (Operation 804) and transmits the received frame to the subordinate user through the user-side communication section 203 (Operation 805). Thereby, for example, the user terminals 101 and 102 can communicate with each other through the data transfer path 602 even if a failure occurs at a network place as shown in FIG. 7.

### 2.4) Path Switching Control in the Event of a Failure (RDB Updating)

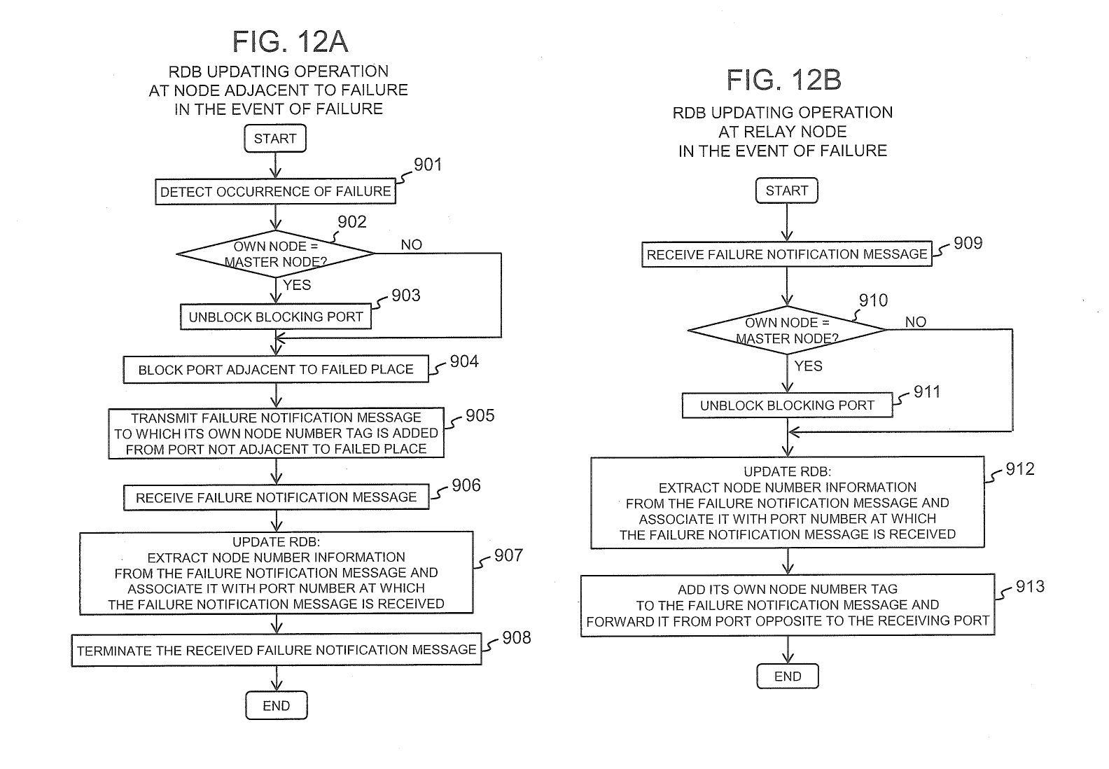

RDB updating operation in the event of a failure differs between a node adjacent to a failed place and a node relaying a failure notification message. Hereinafter, a description will be given with reference to FIG. 12.

Referring to FIG. 12A, at nodes adjacent to a failed place 600 (here, nodes N2 and N3), when the ring-side communication section 201 or 202 detects the occurrence of a failure (Operation 901), the control section 207 determines whether or not its own node is a master node (Operation 902). The control section 207, if its own node is a master node (Operation 902; YES), unblocks a blocking port (Operation 903) and, if its own node is not a master node (Operation 902; NO), controls the ring-side communication section so as to immediately block a port connecting to the failed link (Operation 904)

Subsequently, the control section 207 generates a failure notification message in which its own node number tag is added to the R-APS information field as shown in FIG. 8 and transmits it from the port on a side not connecting to the failed link (Operation 905).

When a failure notification message transmitted by the other node adjacent to the failure is received (Operation 906), the control section 207 updates the RDB 206 such that R-APS information (the source node number and relay node number(s)) in the received failure notification message is associated with a port number at which this failure notification message has been received (Operation 907). Then, the received notification message is terminated (Operation 908).

Referring to FIG. 12B, in the case where the node is a relay node, the control section 207, when receiving a failure notification message (Operation 909), determines whether or not its own node is a master node (Operation 910). The control section 207, if its own node is a master node (Operation 910; YES), unblocks a blocking port (Operation 911) and, if its own node is not a master node (Operation 910; NO), immediately updates the RDB 206 (Operation 912). More specifically, the control section 207 updates the RDB 206 such that R-APS information (the source node number and relay node number(s)) in the received failure notification message is associated with a port number at which this failure notification message has been received (Operation 912). Then, the control section 207 adds its own node number tag to the R-APS information field of the received failure notification message as shown in FIG. 9 or 10 and transmits it from a port opposite to the receiving port (Operation 913).

In this manner, even if a failure occurs at the network place 600 shown in FIG. 7, it is possible to switch the communication path between, for example, the user terminals 101 and 102 from the path 110 shown FIG. 1 to the path 602 shown in FIG. 7, only by updating the RDB 206 of each node.

### 2.5) Path Learning Operation in the Event of a Failure

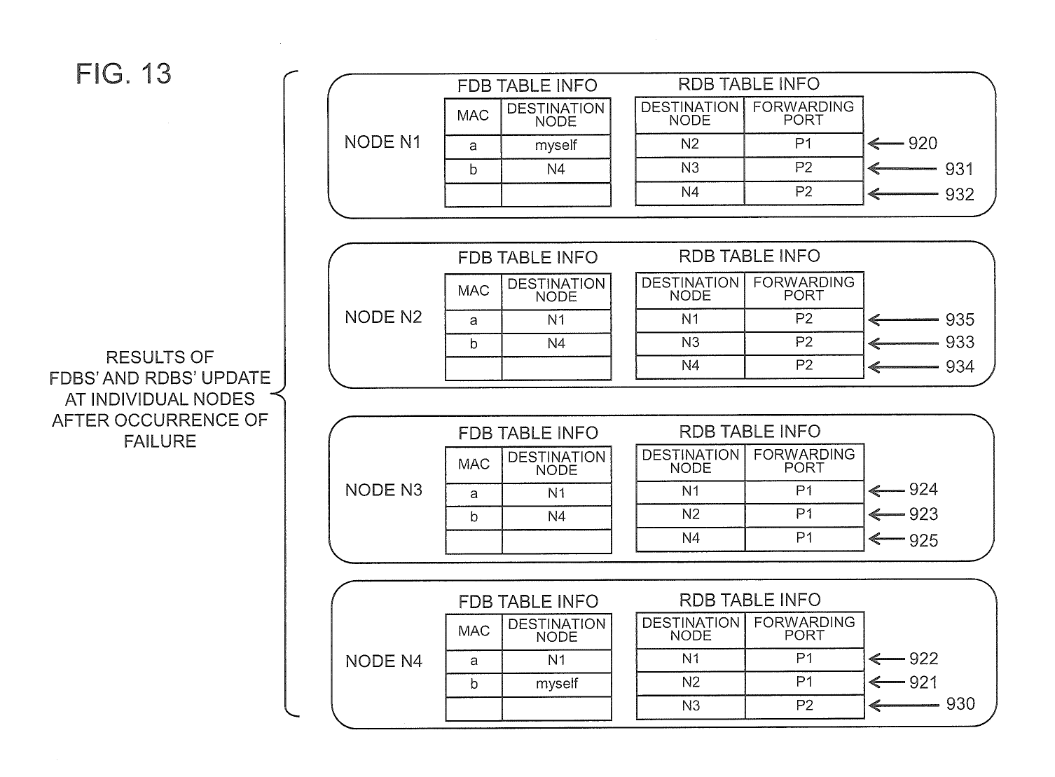

Next, an example of path learning operation (RDB updating) in the event of a failure on the ring network will be described with reference to FIG. 13.

First, a flow of the failure notification message 601 sent out from the node N2 will be described along each node. The node N2 sends out from the port P2 a failure notification message having a source node number tag indicating its own node number, which arrives at the adjacent node N1.

The node N1 receives this failure notification message at the port P1 and recognizes a network failure from the failure information tag 701 in the failure notification message. Since the node N1 is a master node, the node N1 unblocks the port P2. Moreover, the node N1 learns a forwarding port number P1 to be associated with a node number N2 from the source node number tag 702 in the failure notification message and updates the RDB table (at an arrow 920 in FIG. 13; see RDB table information of the node N1). Thereafter, the node N1 forwards the failure notification message from the port P2, which is opposite to the port P1 where the failure notification message has been received. At this time, the node N1 pushes a relay node number tag 703 indicating its own node number following the failure information tag 701 before transmission. The failure notification message arrives at the adjacent node N4.

The node N4 receives this failure notification message at the port P1 and recognizes the network failure from the failure information tag 701 in the failure notification message. The node N4 learns a forwarding port number P1 to be associated with a node number N2 from the source node number tag 702 in the failure notification message and updates the RDB table (at an arrow 921 in FIG. 13; see RDB table information of the node N4). Moreover, the node N4 learns a forwarding destination port number P1 to be associated with a node number N1 from the relay node number tag 703 and updates the RDB table (at an arrow 922 in FIG. 13; see RDB table information of the node N4). Thereafter, the node N4 forwards the failure notification message from the port P2, which is opposite to the port P1 at which the failure notification message has been received. At this time, the node N4 pushes a relay node number tag 703 indicating its own node number following the failure information tag 701 before transmission. The failure notification message arrives at the adjacent node N3.

The node N3 has already detected the failure on the port P2 side when it receives this failure notification message at the port Pl. Therefore, the node N3 learns a forwarding port number P1 to be associated with a node number N2 from the source node number tag 702 in the failure notification message and updates the RDB table (at an arrow 923 in FIG. 13; see RDB table information of the node N3). Moreover, the node N3 learns a forwarding port number P1 to be associated with a node number N1 from the relay node number tag 703 and updates the RDB table (at an arrow 924 in FIG. 13; see RDB table information of the node N3). Further, the node N3 learns a forwarding port number P1 to be associated with a node number N4 from the relay node number tag 703 and updates the RDB table (at an arrow 925 in FIG. 13; see RDB table information of the node N3). Thereafter, the node N3 terminates the failure notification message.

Next, a flow of the failure notification message sent out from the node N3 will be described along each node.

The node N3 sends out a failure notification message having a source node number tag indicating its own node number from the port P1. The failure notification message arrives at the adjacent node N4.

The node N4 receives this failure notification message at the port P2 and recognizes the network failure from the failure information tag 701 in the failure notification message. The node N4 learns a forwarding port number P2 to be associated with a node number N3 from the source node number tag 702 in the failure notification message and updates the RDB table (at an arrow 930 in FIG. 13; see RDB table information of the node N4). Thereafter, the node N4 forwards the failure notification message from the port P1, which is opposite to the port P2 at which the failure notification message has been received. At this time, the node N4 pushes a relay node number tag 703 indicating its own node number following the failure information tag 701 before transmission. The failure notification message arrives at the adjacent node N1.

The node N1 receives this failure notification message at the port P2 and recognizes the network failure from the failure information tag 701 in the failure notification message. Since the node N1 is a master node, the node N1 unblocks the port P2. The node N1 learns a forwarding port number P2 to be associated with a node number N3 from the source node number tag 702 in the failure notification message and updates the RDB table (at an arrow 931 in FIG. 13; see RDB table information of the node N1). Moreover, the node N1 learns a forwarding port number P2 to be associated with a node number N4 from the relay node number tag 703 and updates the RDB table (at an arrow 932 in FIG. 13, see RDB table information of the node N1). Thereafter, the node N1 forwards the failure notification message from the port P1, which is opposite to the port P2 at which the failure notification message has been received. At this time, the node N1 pushes a relay node number tag 702 indicating its own node number following the failure information tag 701 before transmission. The failure notification message arrives at the adjacent node N2.

The node N2 has already detected the failure on the port P1 side when it receives this failure notification message at the port P2. The node N2 learns a forwarding port number P2 to be associated with a node number N3 from the source node number tag 702 in the failure notification message and updates the RDB table (at an arrow 933 in FIG. 13; see RDB table information of the node N2). Moreover, the node N2 learns a forwarding port number P2 to be associated with a node number N4 from the relay node number tag 703 and updates the RDB table (at an arrow 934 in FIG. 13; see RDB table information of the node N2). Further, the node N2 learns a forwarding port number P2 to be associated with a node number N1 from the relay node number tag 703 and updates the RDB table (at an arrow 935 in FIG. 13; see RDB table information of the node N2). The node N2 terminates the failure notification message because it has recognized the failure occurring on the port P1 side.

In this manner, updating of the RDB tables of all nodes is completed. Thereby, for example, when receiving a frame addressed to the user terminal 102 from the user terminal 101, the switching processing section 204 of the node N1 searches the FDB table of the FDB 205 by using a destination MAC address (b) in the header area as a key. Since the destination node N4 is registered, associated with the MAC address b, in the FDB table of the node N1 as shown in FIG. 13, the RDB table of the RDB 206 is subsequently searched by using the destination node N4 as a key. Since the forwarding port P2 is registered, associated with the destination node N4, in the RDB table of the node N1 as shown in FIG. 13, the frame received from the user terminal 101 is transmitted from the port P2.

As described above, according to the present example, even for communication after a failure occurs, it is possible to switch paths at high speed without performing data flooding.

2.6) RDB Updating after Recovery from a Failure

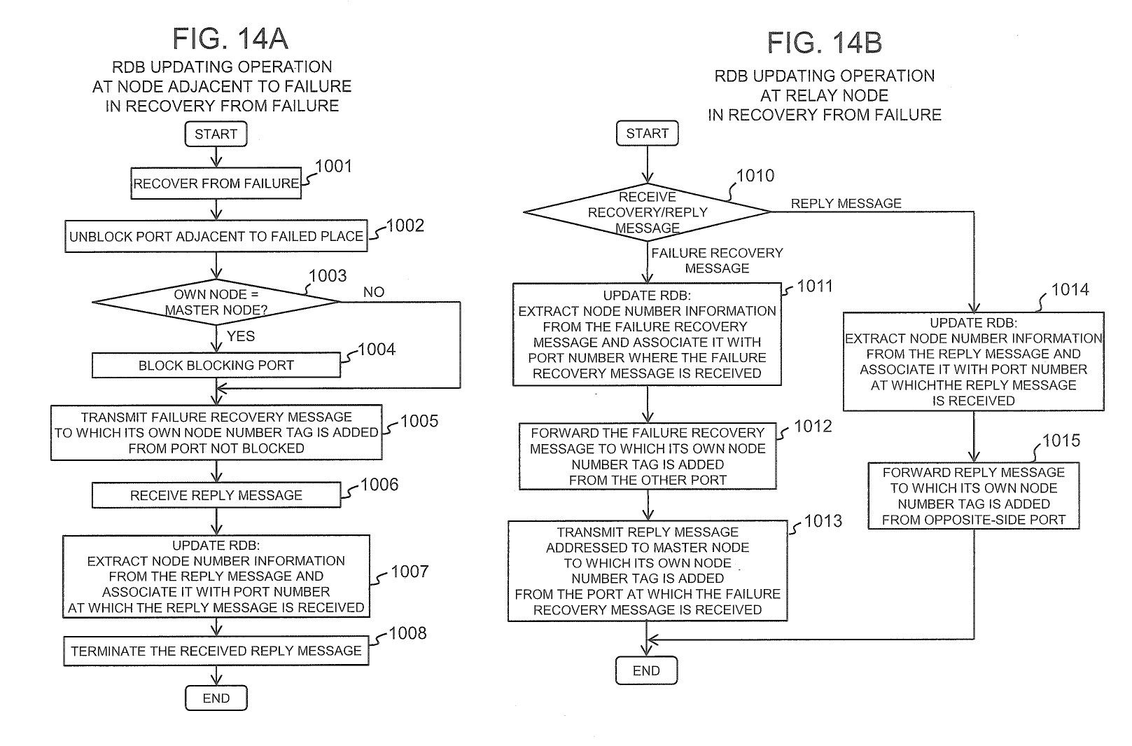

Hereinafter, RDB updating operation after recovery from a failure will be described briefly with reference to FIG. 14.

Referring to FIG. 14A, when a node adjacent to a failed link detects recovery from a failure (Operation 1001), the node unblocks a port that has been blocked due to the failure (Operation 1002). If the own node is a master node (Operation 1003; YES), the node blocks the blocking port (Operation 1004) and transmits a failure recovery message to which its own node number tag is added from the port that is not blocked (Operation 1005). Then, when receiving a reply message having the same format as a failure notification message (Operation 1006), the node extracts node number information from the reply message, updates the RDB table such that the node number information is associated with a port number at which the reply message is received (Operation 1007), and terminates the received replay message (Operation 1008).

Referring to FIG. 14B, when a relay node receives a failure recovery message (Operation 1010; failure recovery message), the relay node extracts node number information from the failure recovery message and updates the RDB table such that the node number information is associated with a port number at which the failure recovery message has been received (Operation 1011). Then, the relay node forwards the failure recovery message to which its own node number tag is added from a port opposite to the port at which the failure recovery message has been received (Operation 1012) and further transmits a reply message addressed to the master node to which its own node number tag is added from the port at which the failure recovery message has been received (Operation 1013). Moreover, when receiving a reply message (Operation 1010; reply message), the relay node extracts node number information from the reply message and updates the RDB table such that the node number information is associated with a port number at which the reply message has been received (Operation 1014). Then, the relay node forwards the reply message to which its own node number tag is added from a port opposite to the port at which the reply message has been received (Operation 1015).

### 2.7) Effects

As described above, according to the present example, a destination node for a destination MAC address is learnt by using the FDB table, and a forwarding port for the destination node is learnt by using the RDB table. Management is performed in such a manner that in the event of a failure, the FDB table is left as it is and only the RDB table is updated. Moreover, in update operation of a forwarding port for a destination node after a failure occurs, a failure notification message is forwarded to all nodes in the ring, and their own node numbers are pushed in the message. Therefore, it is possible to suppress flooding that has been inevitable to happen from the occurrence of a failure up until FDBs relearn, and it is possible to achieve faster path switching operation.

### 3. OTHER EXAMPLES

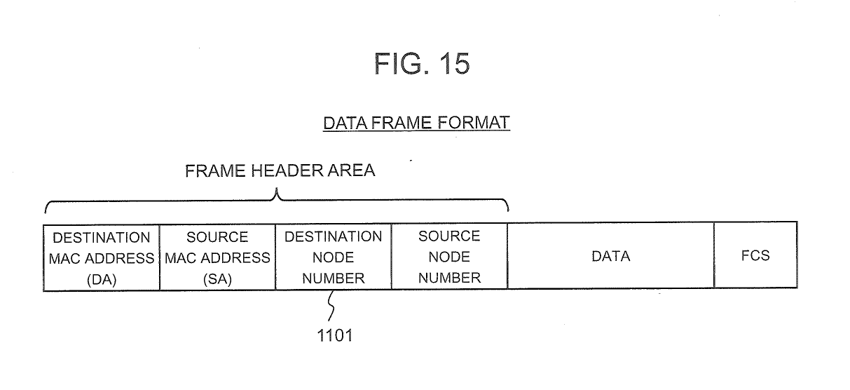

In the above-described example, a source node number is added to a transmission frame's header as shown in FIG. 1B. As another example, it is also possible to add a destination node number preceding the source node number. As an example, as shown in FIG. 15, a destination node number field 1101 is provided in front of the source node number field in the frame header area. In a case of applying this method, there is an advantage that a system can be configured in which a node relaying data between a source node and a destination node can forward the data by learning and referring to only the RDB table, without learning and referring to the FDB table.

Note that this data format is similar to the data format used in PBB (Provider Backbone Bridge) networks defined by IEEE 802.1ah and can be used in PBB networks.

### INDUSTRIAL APPLICABILITY

The present invention is applicable to communication devices (nodes) included in a ring network.

### REFERENCE SIGNS LIST

101, 102 User terminal
110 Data forwarding path
111-113, 121-123 Data frame header
201, 202 Ring-side communication section
203 User-side communication section
204 Switching processing section
205 Forwarding database (FDB)
206 Management database (RDB)
207 Control section
600 Failed place
601 Failure notification message
602 Data forwarding path
603 R-APS information field
701 Failure detection information field
702 Source node number field
703 Relay node number field

1. A node device included in a ring network, comprising:
a plurality of ports connecting to the ring network;
a storage section for storing a forwarding table and a management table, wherein the forwarding table associates a destination node device of forwarded data with an address of the destination node device on the ring network, wherein the management table associates the destination node device with port information on a port to be used for forwarding data to the destination node device; and
a control section for updating the management table without updating the forwarding table when a transfer path of the forwarded data is changed.

2. The node device according to claim 1, wherein when a message about a network failure is received from another node device, the control section updates the management table by associating each node device on a path through which the message arrives with receiving port information on a receiving port at which the message has been received.

3. The node device according to claim 2, wherein either the control section adds identification information of the own node device to the message to forward the message on to the ring network from a port other than the receiving port information or terminates the message.

4. A method for controlling path switching in a ring network in which a plurality of node devices are connected in a ring topology, comprising:
at each of the plurality of nodes, storing in storage means a forwarding table and a management table, wherein the forwarding table associates a destination node device of forwarded data with an address of the destination node device on the ring network, wherein the management table associates the destination node device with port information on a port to be used for forwarding data to the destination node device; and
when a transfer path of the forwarded data is changed, updating the management table without updating the forwarding table.

5. The method according to claim 4, wherein when a message about a network failure is received from another node device, the management table is updated by associating each node device on a path through which this massage arrives with receiving port information on a receiving port at which the message has been received.

6. The method according to claim 5, wherein either identification information of the own node device is added to the message, which is then forwarded on to the ring network from a port other than the receiving port information, or the message is terminated.

7. A ring network in which a plurality of node devices are connected in a ring topology, wherein
each node device comprises: a plurality of ports connecting to the ring network; and a storage section for storing a forwarding table and a management table, wherein the forwarding table associates a destination node device of forwarded data with an address of the destination node device on the ring network, wherein the management table associates the destination node device with port information on a port to be used for forwarding data to the destination node device,
wherein, when a forwarding path of the forwarded data is changed, each node device updates the management table without updating the forwarding table.

8. The ring network according to claim 7, wherein when a message about a network failure is received from another node device, the control section updates the management table by associating each node device on a path through which the message arrives with receiving port information on a receiving port at which the message has been received.

9. The ring network according to claim 8, wherein the control section adds identification information of the own node device to the message to forward the message on to the ring network from a port other than the receiving port information or terminates the message.

10. (canceled)

11. The node device according to claim 1, wherein the control section updates an association of the destination node device with the port information in the management table.

12. The method according to claim 4, wherein only an association of the destination node device with the port information is updated in the management table.

13. The ring network according to claim 7, wherein each node device updates an association of the destination node device with the port information in the management table.
